(19) United States
(12) Patent Application Publication
(10) Pub. No.: US 2015/0100984 A1
(43) Pub. Date: Apr. 9, 2015

(54) PLAYBACK DEVICE AND PLAYBACK METHOD FOR MULTIMEDIA FILE

(71) Applicant: MStar Semiconductor, Inc., Hsinchu Hsien (TW)

(72) Inventors: Hsiao-Shu Hsiung, San Jose, CA (US); Tsung-Hsun Tsai, Hsinchu Hsien (TW)

(21) Appl. No.: 14/510,161

(22) Filed: Oct. 9, 2014

Related U.S. Application Data
(60) Provisional application No. 61/888,554, filed on Oct. 9, 2013.

(51) Int. Cl. H04N 21/482; H04N 21/472; H04N 21/858

(52) U.S. Cl. CPC H04N 21/4825; H04N 21/4821; H04N 21/8586; H04N 21/47217
USPC 725/39

(57) ABSTRACT

A playback device for a multimedia file is provided. The playback device is applied to a player that switches a channel according to a control signal. The playback device for a multimedia file includes: a processing unit, configured to access one of a plurality of sets of playlist link information from a look-up table according to the control signal, and to obtain a playlist according to the selected playlist link information; a multimedia content identification unit, configured to access the multimedia file according to contents of the playlist; and an image processing unit, configured to process the multimedia file and to transmit the processed multimedia file to a display module for display.

This application claims the benefit of U.S. provisional application Ser. No. 61/888,554, filed Oct. 9, 2013, the subject matter of which is incorporated herein by reference.

### BACKGROUND OF THE INVENTION

1. Field of the Invention

The invention relates in general to a playback device and a playback method for a multimedia file, and more particularly to a playback device and a playback method that quickly access and play a multimedia file from a network by switching a channel of the playback device.

2. Description of the Related Art

Most current commercial smart televisions provide users with a function of browsing and playing multimedia files from networks. For example, the multimedia files are stored on a server device, and provide the users with audio or video files through a streaming technology. To view such type of remote multimedia files, a user needs to activate a corresponding application program on the smart television, and to search programs of interest through the application program to further play the programs of interest. However, a main function of a television is still receiving and playing real-time television programs, e.g., program contents that are broadcasted through terrestrial broadcasting or cable television. Such type of program contents may be referred to as linear programs featuring real-time audio and video contents fed to viewers, who passively receive such audio and video contents. On the other hand, multimedia files stored on servers are referred to as non-linear programs, which feature non-predetermined broadcast timeslots, and viewers may initiatively search and watch program contents of interest at all times. When a user of a smart television wishes to view a non-linear program, base on current designs, the user needs to activate a corresponding application program. Compared to linear programs that can be conveniently viewed by switching between channels and quickly selecting different program contents, viewing non-linear programs is quite inconvenient. More particularly, when a user wishes to switch from a linear program to a non-linear program, before being able to view the desired non-linear program, the user needs to go through a procedure of exiting a playback image of the current linear program, entering a menu of application programs, and selecting and executing the corresponding application program. The above complicated procedure may result in an unpleasant user experience. Therefore, there is a need for a device and a method that allow a user to readily view a non-linear program, or to easily switch between a linear program and a non-linear program.

### SUMMARY OF THE INVENTION

The invention is directed to a playback device and a playback method for a multimedia file, so that non-linear programs can be more conveniently played on the playback device for a multimedia file.

The present invention discloses a playback method for a multimedia file. The playback method is applied to a player that switches a channel according to a control signal. The playback method includes: selecting one of a plurality of sets of playlist link information from a look-up table according to the control signal; obtaining a corresponding playlist according to the selected playlist link information; accessing a multimedia file according to contents of the playlist; and processing and playing the multimedia file.

The present invention further discloses a playback device for a multimedia file. The playback device is applied to a player that switches a channel according to a control signal. The playback device includes: a processing unit, configured to select one of a plurality of sets of playlist link information from a look-up table according to the control signal, and to obtain a playlist according to the selected playlist link information; a multimedia content identification unit, configured to access a multimedia file according to contents of the playlist; and an image processing unit, configured to process the multimedia file and to transmit the processed multimedia file to a display module for display.

The present invention further discloses a playback method applied to a player that switches a channel according to a control signal. The playback method includes: selecting a target linear multimedia file from a plurality of linear multimedia files, the linear multimedia files correspond to respective channel numbers; processing and playing the target linear multimedia file; obtaining a playlist according to the control signal, the playlist recording a plurality of URLs of a plurality of non-linear multimedia files; accessing one of the non-linear multimedia files according to one of the URLs; and processing and playing the accessed non-linear multimedia file.

The playback device and the playback method for a multimedia file allow a player (e.g., a television set or a set-up box) that a user applies to a playback device of a multimedia file to quickly access and play a multimedia file stored on a server device. Compared to a conventional playback device for a multimedia file, the present invention allows a user to readily switch between a linear program and a non-linear program by simply using a channel switch key, thereby significantly enhancing the ease of use.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a playback device of a multimedia file according to an embodiment of the present invention;

FIG. 2 is a schematic diagram of a look-up table (LUT) according to an embodiment of the present invention;

FIG. 3 is a schematic diagram of a playlist according to an embodiment of the present invention;

FIG. 4 is a flowchart of a playback method for a multimedia file according to an embodiment of the present invention;

FIG. 5 is a flowchart of a playback method for a multimedia file according to another embodiment of the present invention;

FIG. 6 is a schematic diagram of a playback device for a multimedia file according to another embodiment of the present invention;

FIG. 7 is a schematic diagram of an LUT according to another embodiment of the present invention;

FIG. 8 is a flowchart of a playback method for a multimedia file according to another embodiment of the present invention;

FIG. 9 is a flowchart for generating or updating an LUT of the present invention; and

FIG. 10 is a schematic diagram of an LUT according to another embodiment of the present invention.

### DETAILED DESCRIPTION OF THE INVENTION

Technical terms of the application are based on the general definition in the technical field of the application. If the application describes or explains one or some terms, definitions of the terms are based on the description or explanation of the application.

The present invention discloses a playback device and a playback method for a multimedia file that are capable of playing a multimedia file stored on a server according to a playlist. The device and the method are applicable to a multimedia apparatus for playing linear programs and non-linear programs. In possible implementation, one skilled person in the art may choose equivalent elements or steps to implement the disclosure based on the disclosure of the application. That is, the implementation of the disclosure is not limited by the embodiments disclosed in the disclosure. Further, a part of the elements included in the playback device for a multimedia file of the disclosure are individually known elements. Without affecting the full disclosure and possible implementation of the device, details of the known elements are omitted. Further, the playback method for a multimedia file of the present invention may be implemented by the playback device of the disclosure or an equivalent device. Without affecting the full disclosure and possible implementation of the method of the disclosure, the description of the method focuses on the steps of the method instead of hardware.

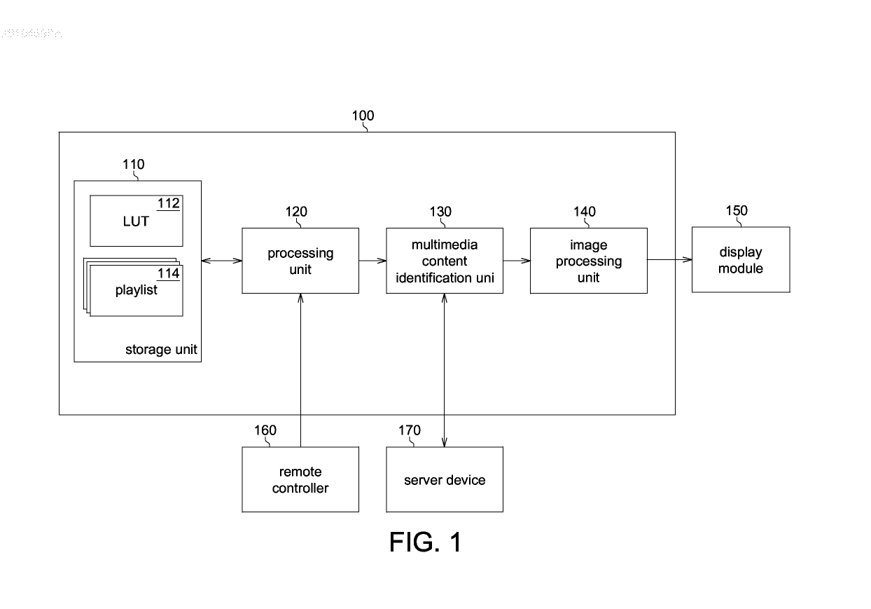

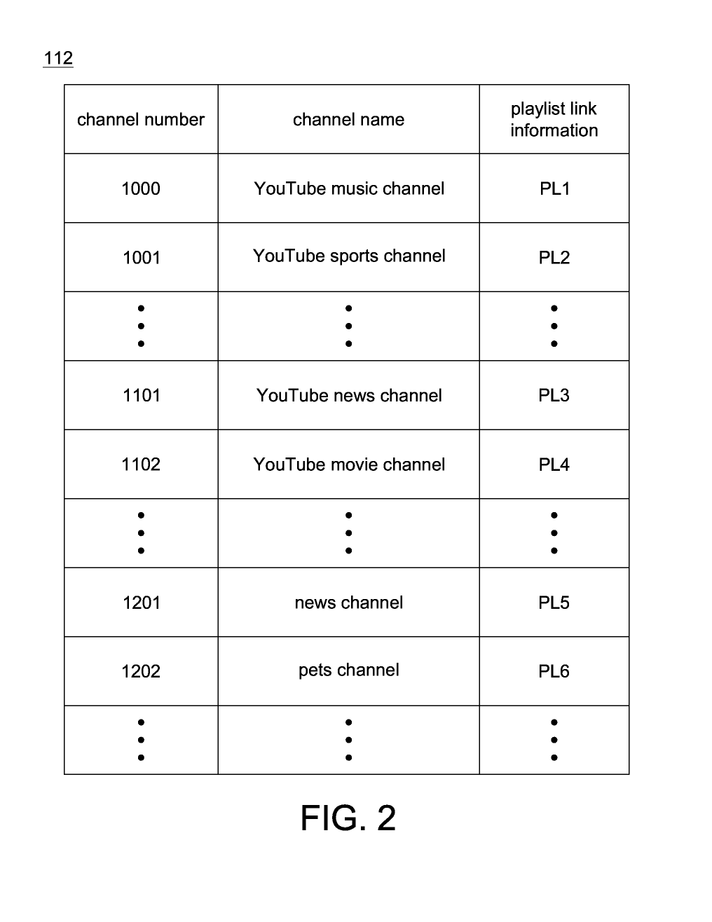

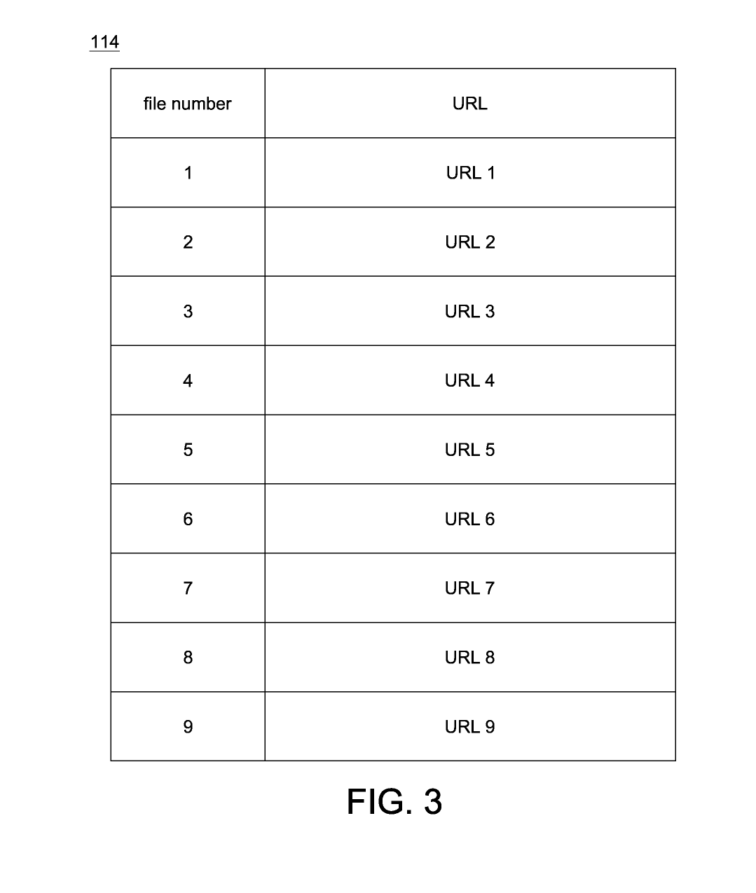

FIG. 1 shows a schematic diagram of a playback device for a multimedia file according to an embodiment of the present invention. Referring to FIG. 1, a playback device 100 for a multimedia file includes a storage unit 110, a processing unit 120, a multimedia content identification unit 130, and an image processing unit 140. Upon receiving a command from a remote controller 160, the processing unit 120 accesses a look-up table (LUT) 112 in the storage unit 110 to further obtain a multimedia playlist 114. FIG. 2 shows a schematic diagram of a LUT 112 according to an embodiment of the present invention. The LUT 112 includes fields of channel number, channel name and playlist link information. For example, the channel number 1000 is a YouTube music channel that presents contents accessed from music-related multimedia files from the network video/audio sharing platform YouTube; the channel number 1202 is a pets channel that presents pet-related multimedia files accessed from a network. The above multimedia files may include audio and video, and are stored at a server device on a network. The server device may be located on the Internet provided by a sharing platform, or may be located in an intranet or a LAN and provided by an individual or a small-size organization. Each multimedia file has its own Uniform Resource Locator (URL), whether an Internet URL, an intranet URL or a LAN URL. A set of the URL of these multimedia files compose a playlist 114 shown in FIG. 1. FIG. 3 shows a schematic diagram of a playlist 114 according to an embodiment of the present invention. Fields of the playlist 114 include file numbers and URLs, with each file number corresponding to one URL and pointing to one multimedia file. For example, in a preferred embodiment, according to a control signal from the remote controller 160, e.g., a control signal for switching the channel, the processing unit 120 in FIG. 1 identifies the corresponding playlist link information from a plurality sets of playlist link information recorded in the LUT 112 according to the control signal, and accordingly identifies the corresponding playlist 114 according to the playlist link information. For example, assuming a channel 1001 is selected, the processing unit 120 then identifies the corresponding playlist 114 according to playlist link information PL2. As the channel 1001 is a sports channel, URLs 1 to 9 point to multimedia files associated with sports events. It should be noted that, the storage unit 110 stores a plurality of playlists 114 each corresponding to one set of playlist link information. Further, apart from being stored in the storage unit 110, the playlist 114 may be stored in a remote device, e.g., on a server device. When the playlist 114 is stored in the storage unit 110, the playlist link information is a memory address of the playlist 114 in the storage unit. When the playlist 114 is stored in a remote device, the playlist link information is a URL that points to the playlist 114. Further, the LUT 112 may also be stored in a remote device, e.g., on a server device, and the processing unit 120 may log into the server device according to user-provided information to obtain the LUT 112. Thus, the same LUT 112 may be obtained for different playback devices for a multimedia file, and may be used by different users.

After obtaining the playlist 114, the processing unit 120 controls the multimedia content identification unit 130 to obtain (download) the corresponding multimedia file from a server device 170 according to the URL in the playlist 114. The downloaded multimedia file is processed by the processing unit 140 to generate video/audio data that can then be forwarded to and played by a display module 150.

The playback device 100 for a multimedia file may be a component of a player (e.g., a television set or a set-up box (STB)). When the playback device 100 for a multimedia file is applied to a television set, the display module 150 is a screen and an associated control circuit of the television set. When the playback device 100 for a multimedia file is applied to an STB, the display module 150 is a display module in the television set and is connected to the STB.

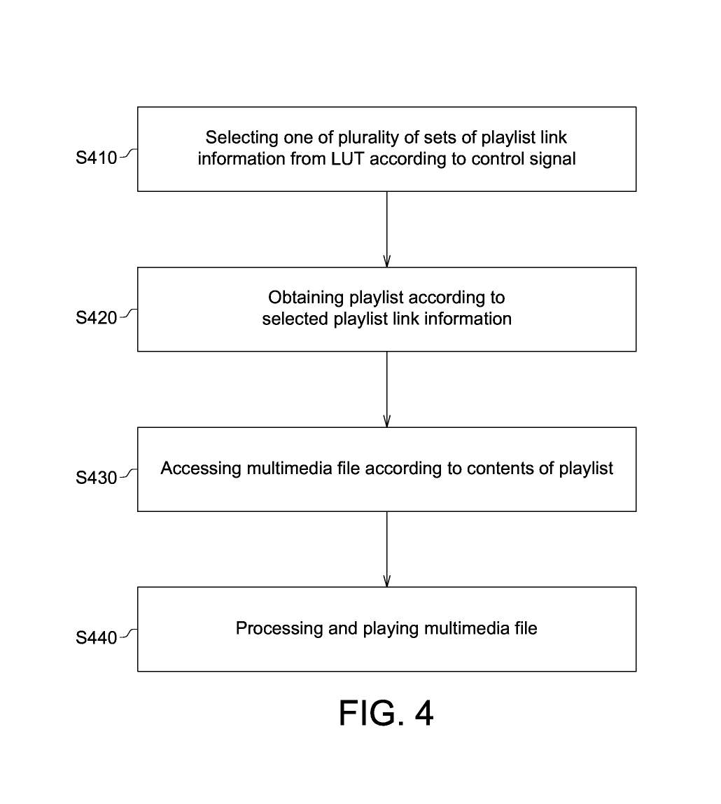

FIG. 4 shows a flowchart of a playback method for a multimedia file according to an embodiment of the present invention. The playback method includes the following steps.

In step S410, one of a plurality sets of playlist link information is selected from the LUT 112 according to a control signal. The method is applicable to a television set or an STB, and the control signal may be a control signal for switching a channel. According to a currently selected channel, the step obtains the corresponding playlist link information from the LUT (as shown in FIG. 2). For example, the channel number 1001 is selected, and the playlist link information is PL2.

In step S420, a corresponding playlist is obtained according to the selected playlist link information. Each set of playlist link information points to one playlist. The corresponding playlist may be obtained according to the playlist link information obtained in step S410. The playlist may be as shown in FIG. 3.

In step S430, the multimedia file is accessed according to contents of the playlist. According to a URL recorded in the playlist obtained in step S420, the corresponding multimedia file is downloaded from a server device. The multimedia file may include audio and video.

In step S440, the multimedia file is processed and played. After having downloaded the multimedia file, the multimedia file is appropriately processed to generate playable video/audio data that is then played.

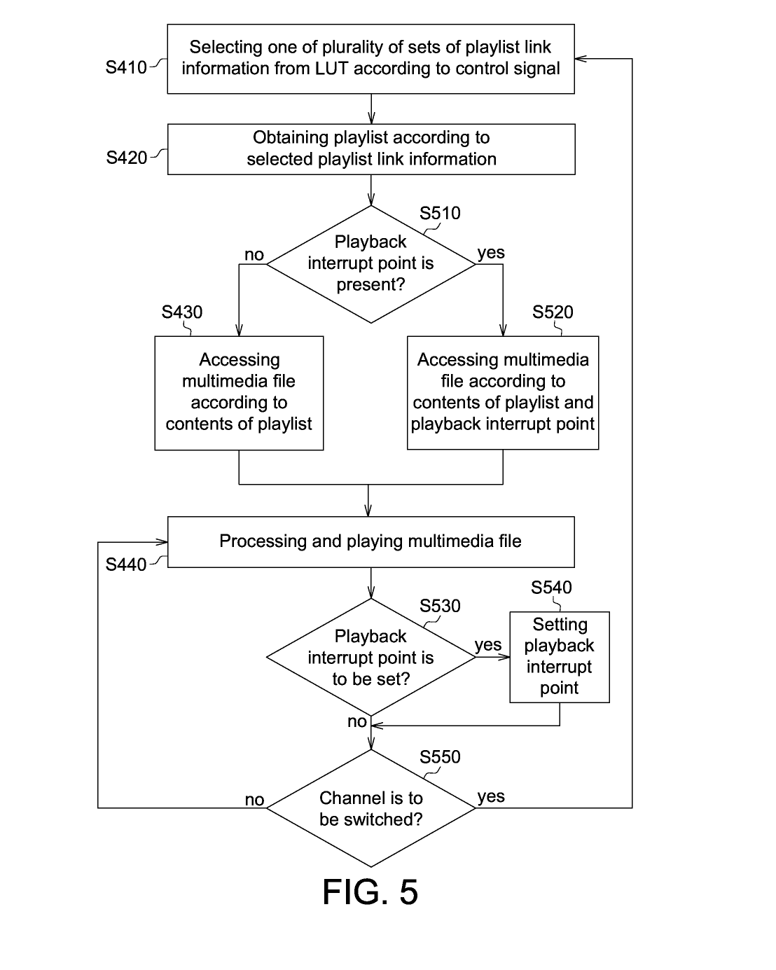

When playing the multimedia file, the above playback method or the playback device 100 for a multimedia file sequentially accesses the file 1 to the file 9 of the playlist 114, and repeats the file 1 after having played the file 9. In an embodiment, each time when the channel is selected, the playback begins from the file 1 instead of resuming the playback from an interrupt point when the multimedia is previously viewed. In a preferred embodiment, the processing unit 120 may further set a playback interrupt point according to a current playback position of the multimedia file. For example, assuming that playback interrupt point indicates that a last viewed position is a middle position of the file 3, when the playback is resumed, the processing unit 120 may then inform the multimedia content identification unit 130 to obtain the correct multimedia file according to the playback interrupt point, i.e., to obtain the multimedia file from the middle position of the file 3. The interrupt point may be stored in the storage unit 110. Therefore, the present invention further discloses a playback method for a multimedia file according to another embodiment of the present invention. FIG. 5 shows a flowchart of a playback method for a multimedia file according to another embodiment of the present invention. In addition to Steps S410 to S440 that are identical to those in the previous embodiment, the playback method of this embodiment further includes the following steps.

In step S510, after step S420 obtains the playlist, it is checked whether a playback interrupt point exists. Step S520 is performed if so, or else step S430 is performed if not.

In step S520, the multimedia file is accessed according to contents of the playlist and the playback interrupt point. For example, assuming that the playback interrupt point records a middle position of the file 4 previously played, the playback of the multimedia file can be resumed from the last interrupted position after the process performed by step S440.

In step S530, it is determined whether a playback interrupt point is to be set during the playback process. Step S540 is performed if the user wishes to set the playback interrupt point, or else step S550 is performed.

In step S540, the playback interrupt point is set according to the currently played file number and playback progress.

In step S550, it is determined whether the channel is to be switched. If the user switches the channel, step S410 is iterated to again obtain one of a plurality sets of playlist link information. Otherwise, step S440 is performed if the channel is not switched, and the playback of the current multimedia file is continued.

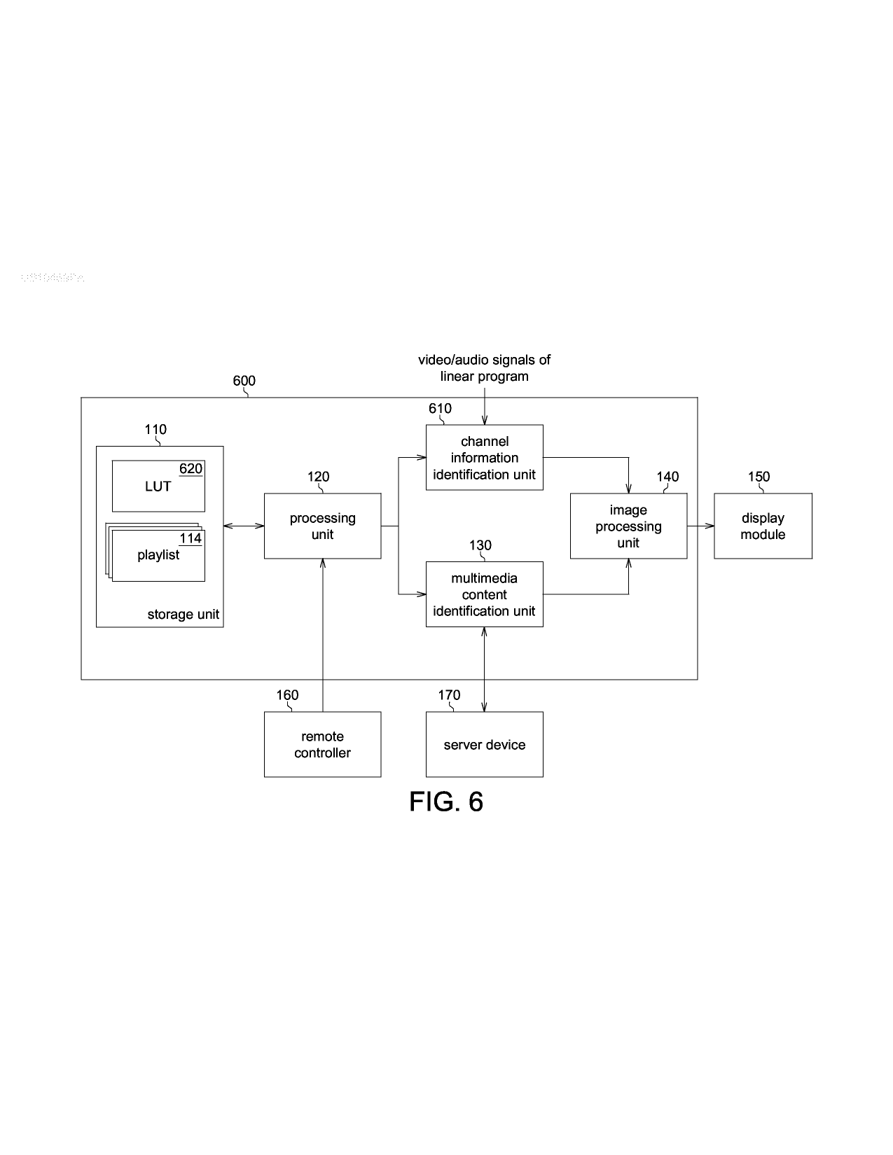

According to another embodiment of the present invention, the playback device and the playback method for a multimedia file of the present invention may combine a linear program with a non-linear program to facilitate the switching of programs of two different forms. FIG. 6 shows a schematic diagram of a playback device for a multimedia file according to an embodiment of the present invention. A playback device 600 for a multimedia file of this embodiment is similar to the playback device 100 for a multimedia file in FIG. 1. In addition to the storage unit 110, the processing unit 120, the multimedia content identification unit 130 and the image processing unit 140, the playback device 600 further includes a channel information identification unit 610. Details of the identical elements having identical functions in this embodiment as those in the embodiment shown in FIG. 1 are omitted herein. The channel information identification unit 610 receives a linear program of a corresponding frequency band according to channel information provided by the processing unit 120, and video/audio signals of the linear program are processed by the image processing unit 140 and then forwarded to the display module 150 for playback.

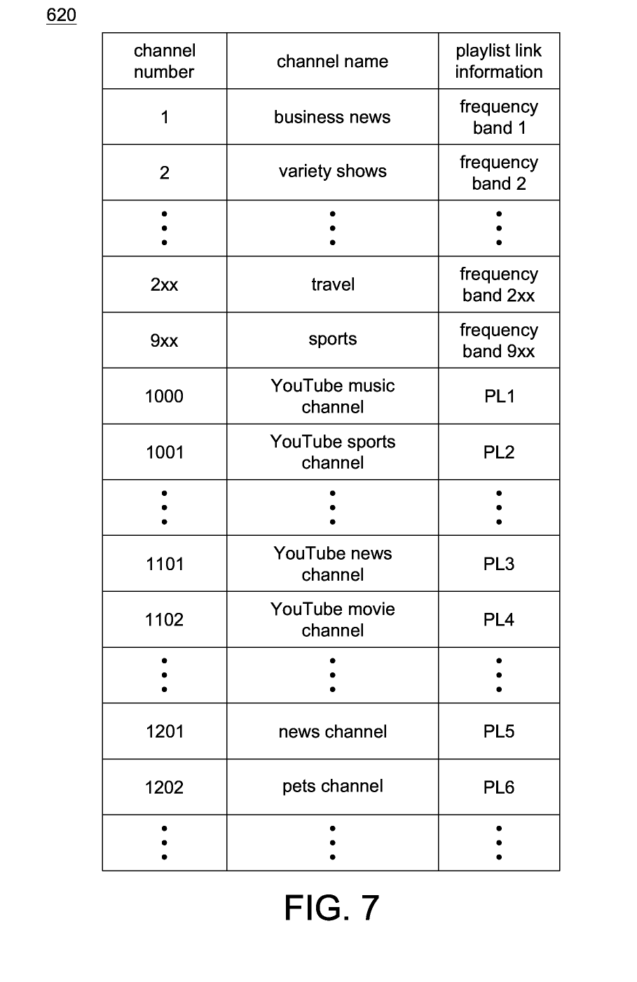

To smoothly switch between a linear program and a non-linear program, an LUT 620 of this embodiment needs to be adjusted. FIG. 7 shows a schematic diagram of the LUT 620 according to another embodiment of the present invention. One difference of the LUT 620 from the LUT 112 is, in the LUT 620, programs before the channel number 1000 (a non-limiting example for explaining the present invention) are linear programs, and programs after the channel number 1000 are non-linear programs. For a linear program, the playlist link information records the frequency band of television programs. When a user selects a linear program, e.g., a program of a variety show of the channel number 2, the processing unit 120 learns the frequency band (i.e., the frequency band 2) corresponding to the channel number 2 according to the LUT 620, and thus the channel information identification unit 610 may then receive linear programs of the frequency band 2. When the user wishes to view a non-linear program, the non-linear program can be directly viewed by switching the desired channel number by utilizing a channel selection key on the remote controller. Processing details of non-linear programs are as disclosed in the description associated with the embodiment in FIG. 4, and shall be omitted herein. It should be noted that, the processing unit 120 may generate channel information of non-linear programs by scanning program channels. For example, the channel information includes channel number, channel name and channel frequency band. The processing unit 120 then downloads a list of the non-linear programs from a server device, and integrates the downloaded list into the channel information. For example, blank channel numbers in an original linear program list are assigned to the non-linear programs, i.e., linking the blank channel numbers with the playlist link information. Thus, the LUT 620 with channel numbers as indices is obtained.

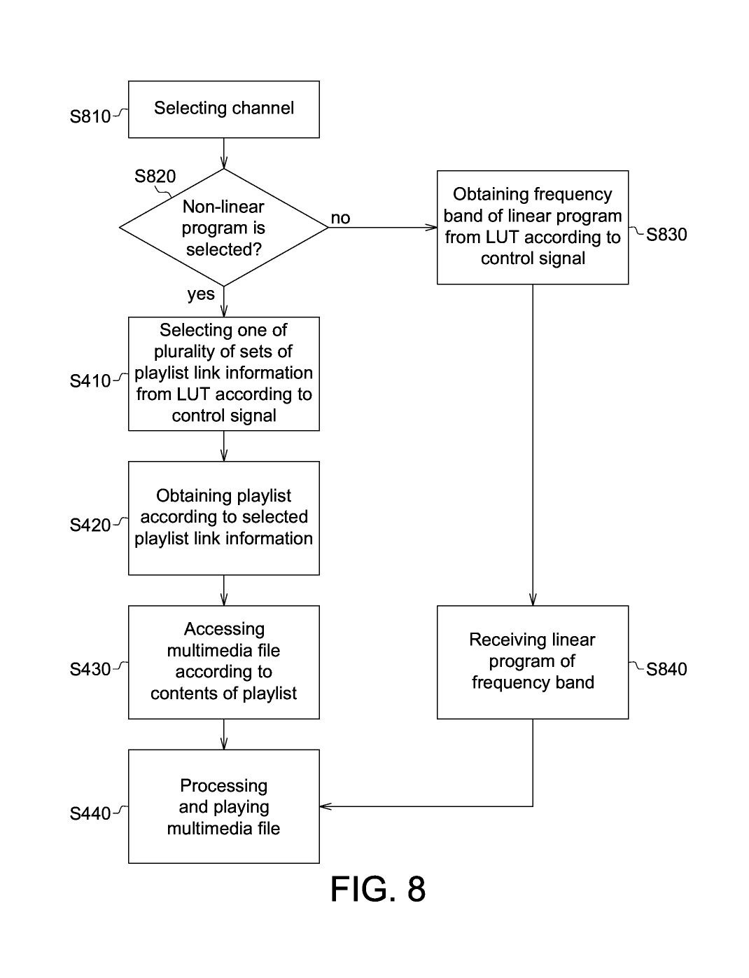

FIG. 8 shows a flowchart of a playback method for a multimedia file according to another embodiment of the present invention. The playback method includes the following steps.

In step S810, a channel is selected according to a control signal. For example, the control signal is a channel selecting signal from a remote controller.

In step S820, it is determined whether a program of the selected channel is a linear program or a non-linear program. Steps S410 to S440, which are previously described in the embodiment in FIG. 4, are performed when the program of the selected channel is a linear program. Step S840 is performed when the program of the selected channel is a non-linear program.

In step S830, a frequency band of the linear program is obtained from an LUT according to the control signal. The LUT records respective frequency bands corresponding to the channels, so that the corresponding frequency band can be selected according to the channel number indicated by the control signal.

In step S840, according to the linear program of the frequency band obtained in the last step, step S440 is performed to process and play the received television program.

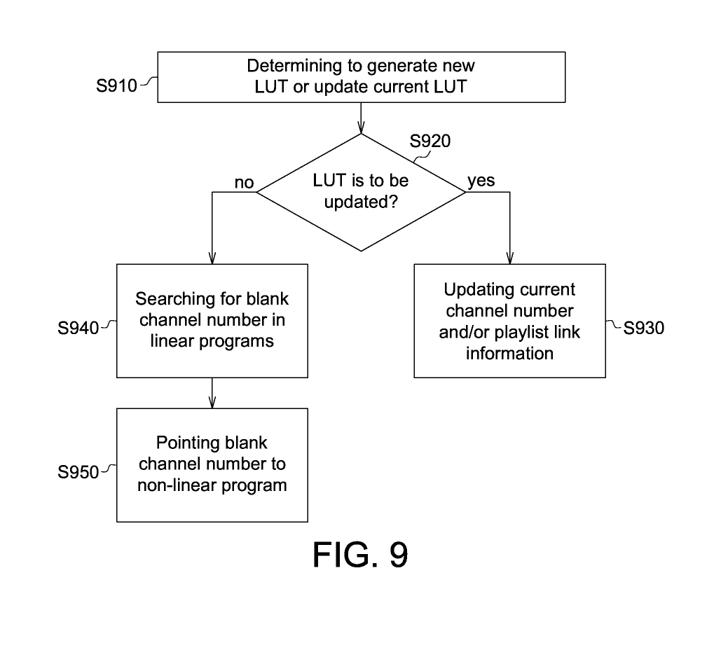

The LUT 620 may be generated or updated according to the flowchart in FIG. 9. Referring to the flowchart in FIG. 9, a process for generating or updating an LUT according to an embodiment of the present invention includes the following steps.

In step S910, it is determined whether to generate a new LUT or to update a current LUT.

In step S920, step S930 is performed when the last step determines to update the current LUT, or else step S940 and step S950 are performed when the last step determines to generate a new LUT.

In step S930, the current channel number and/or playlist link information are/is updated according to the newly obtained channel information. For example, referring to FIG. 7, assuming a provider (e.g., a cable television service provider) of the linear program changes the program of the variety show from the channel number 2 to the channel number 3, the program of the variety show then needs to be updated to the channel number 3, and the playlist link information is correspondingly assigned to the channel 3.

In step S940, channel information is generated according to the linear program. For example, channel information is generated by scanning channels, and blank (unutilized) channel numbers are identified from the channel information, i.e., channel numbers without assigned programs.

In step S950, after having identified the channel numbers, the blank channel numbers are assigned to non-linear programs. For example, a blank channel number is linked to the playlist link information. Thus, when that channel number is next selected, the non-linear program corresponding to the channel number can be viewed. Further, the obtained LUT utilizes the channel number as an index.

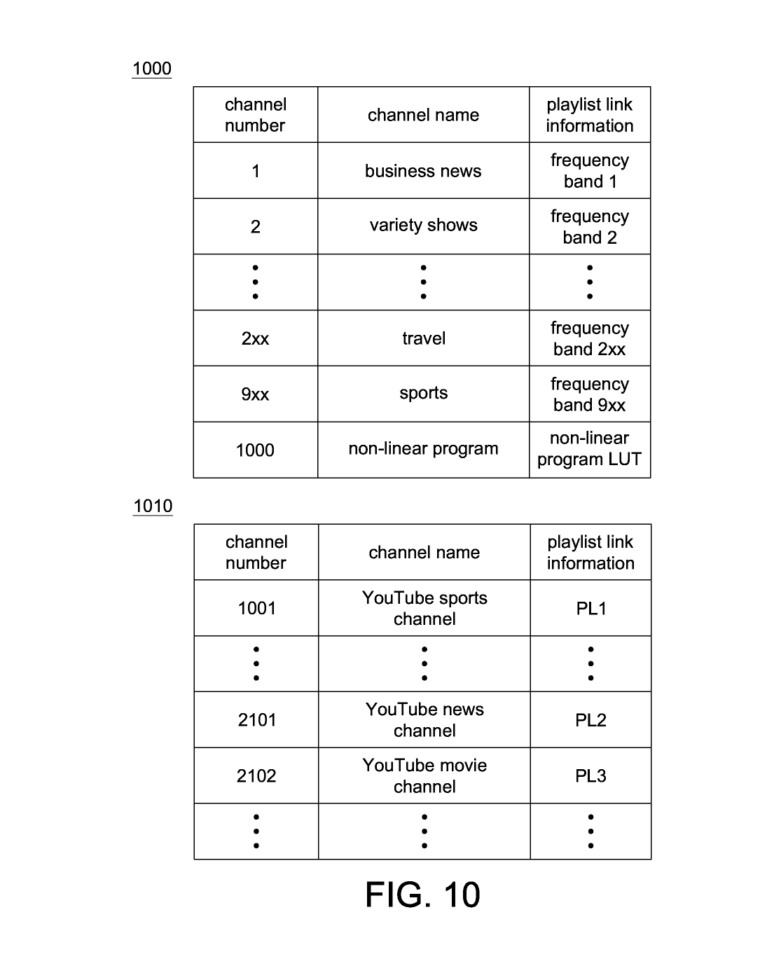

In another embodiment, a two-tier LUT may be utilized to integrate linear programs and non-linear programs. FIG. 10 shows a schematic diagram of an LUT according to another embodiment of the present invention. An LUT 1000 includes a linear program list having channel numbers smaller than 1000 and a non-linear program list having a channel number 1000. When generating the LUT 1000, the processing unit 120 assigns a blank channel number (1000 in this example) to an LUT 1010 of non-linear programs. When the selected channel number is smaller than 1000, the television set or STB plays a linear program. When the selected channel number is 1000, the processing unit 120 obtains the LUT 1010 according to the channel number 1000, and the television set or STB displays the LUT 1010. The LUT 1010 records channel numbers of non-linear programs, the corresponding channel names and the playlist link information. A user then accesses a desired non-linear program according to the LUT 1010.

It should be noted that, the LUT 112, LUT 620 and the playlist 114 of the present invention may be stored on a server device, and accessed by a television set or STB via a network (a LAN or the Internet) or downloaded to storage units of respective devices, i.e., the storage unit 110 in FIG. 1 and FIG. 6. Further, when the LUT 112 and the LUT 620 are stored on a server device, the same LUT may be accessed by different users through setting permission levels. Thus, the LUT can be shared among different users to increase utilization flexibility and convenience. The playlist 114 may be dynamically updated according to different application scenarios and requirements. In a preferred embodiment, the playlist 114 in FIG. 3 are predetermined or dynamically determined by a non-linear program maintenance provider. For example, a playlist may be updated for program contents of the YouTube news channel every hour to ensure that users receive the latest news contents.

With the device in FIG. 6 and the method in FIG. 8, a user can easily switch between a linear program and a non-linear program. By simply utilizing a channel selection key on a remote controller, a television set or STB correspondingly processes the linear program or non-linear program according to the selected channel. Further, by integrating linear programs and non-linear programs into one playback interface, a user is able to view multimedia files on a network without undergoing a procedure of selecting and executing a specific application program, thereby significantly enhancing the ease of use.

One person skilled in the art can understand details and possible implementation variations of the method in FIG. 4 and FIG. 5 according to the disclosure of the playback device in FIG. 1. Without affecting the full disclosure and possible implementation, such repeated description is omitted herein. Further, the shapes, sizes, ratios and sequences of the steps in the drawings are examples for explaining the present invention to one person skilled in the art, not limiting the present invention. In possible implementation, one skilled person in the art would selectively implement part or all technical features of any embodiment of the application or selectively combine part or all technical features of the embodiments of the application based on the disclosure of the present invention to enhance the implementation flexibility of the present invention. Further, although a television set and an STB are taken as an example in the foregoing embodiments, based on the disclosure of the present invention, one person skilled in the art may appropriately apply the present invention to other types of playback devices for a multimedia file.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A playback method, applied to a player that switches a channel according to a control signal, the playback method comprising:
selecting one of a plurality sets of playlist link information from a look-up table (LUT) according to the control signal;
obtaining a corresponding playlist according to the selected set of playlist link information;
accessing a multimedia file according to contents of the playlist; and
playing the multimedia file.

2. The playback method according to claim 1, the player generating channel information including a plurality of channel numbers according to a plurality of multimedia contents broadcasted in real-time, the playback method further comprising:
generating the LUT according to the channel information and the plurality sets of playlist link information;
wherein, the LUT utilizes the channel numbers as indices, and one target channel number of the channel numbers is assigned to the selected set of playlist link information.

3. The playback method according to claim 1, the player generating channel information including a plurality of channel numbers according to a plurality of multimedia contents broadcasted in real-time, the playback method further comprising:
assigning one target channel number of the channel numbers to the LUT;
wherein, the control signal is for assigning the target channel number.

4. The playback method according to claim 1, wherein the playlist includes a plurality of Uniform Resource Locators (URLs) each corresponding to one specific multimedia file.

5. The playback method according to claim 1, the LUT being stored in a server device, the playback method further comprising:
logging into the server device to obtain the LUT.

6. The playback method according to claim 1, wherein each of the plurality sets of playlist link information is a URL.

7. The playback method according to claim 1, further comprising:
setting a playback interrupt point;
wherein, the step of accessing the multimedia file according to the contents of the playlist further comprises:
accessing the multimedia file according to the playback interrupt point.

8. The playback method according to claim 1, wherein the player is one of a television set and a set-up box (STB).

9. A playback device, applied to a player that switches a channel according to a control signal, the playback device comprising:
a processing unit, configured to select one of a plurality sets of playlist link information from an LUT according to the control signal, and to obtain a playlist according to the selected playlist link information;
a multimedia content identification unit, configured to access a multimedia file according to contents of the playlist; and
an image processing unit, configured to process the multimedia file and to transmit the processed multimedia file to a display module for display.

10. The playback device according to claim 9, wherein the processing unit generates channel information including a plurality of channel numbers according to a plurality of multimedia contents broadcasted in real-time, and generates the LUT according to the channel information and the plurality sets of playlist link information; the LUT utilizes the channel numbers as indices, and one target channel number of the channel numbers is assigned to the selected playlist link information.

11. The playback device according to claim 9, wherein the processing unit generates channel information including a plurality of channel numbers according to a plurality of multimedia contents broadcasted in real-time, and assigns one target channel number from the channel numbers to the LUT; the control signal is for assigning the target channel number.

12. The playback device according to claim 9, wherein the playlist includes a plurality of URLs each corresponding to one specific multimedia file.

13. The playback device according to claim 9, wherein the LUT is stored in a server device, and the processing unit obtains the LUT from the server device according to user information.

14. The playback device according to claim 9, wherein each of the plurality sets of playlist link information is a URL.

15. The playback device according to claim 9, wherein the processing unit sets a playback interrupt point according to a playback position, and the multimedia content identification unit obtains the multimedia file according to the playback interrupt point.

16. The playback device according to claim 9, wherein the player is one of a television set and an STB.

17. A playback method, applied to a player that switches a channel according to a control signal, the playback method comprising:
selecting a target linear multimedia file from a plurality of linear multimedia files, the linear multimedia files correspondingly to respective channel numbers;
processing and playing the target linear multimedia file;
obtaining a playlist according to the control signal, the playlist recording a plurality of URLs of a plurality of non-linear multimedia files;
accessing one of the non-linear multimedia files according to one of the URLs; and
processing and playing the accessed non-linear multimedia file.

18. The playback method according to claim 18, the player generating channel information including a plurality of channel numbers according to the linear multimedia files, the playback method further comprising:
generating a LUT according to the channel information;
wherein, the LUT utilizes the channel numbers as indices, and the step of obtaining the playlist according to the control signal obtains the playlist by referring to the LUT.

19. The playback method according to claim 18, wherein the step of generating the LUT according to the channel information comprises:
assigning one target channel number of the channel numbers to the playlist.

20. The playback method according to claim 17, further comprising:
setting a playback interrupt point;
wherein, the step of accessing one of the non-linear multimedia files according to one of the URLs comprises:
accessing the accessed non-linear multimedia file according to the playback interrupt point.
